(19) United States
(12) Patent Application Publication
(10) Pub. No.: US 2010/0099387 A1
(43) Pub. Date: Apr. 22, 2010

(54) Controlling and/or Limiting Publication Through the Presence Access Layer

(75) Inventors: Sin-Hang SO, Richmond Hill (CA); Jeff ROGERS, Scarborough (CA); Michael Hin Kai HUNG, Toronto (CA); Brian MCCOLGAN, Toronto (CA)

Correspondence Address: Research in Motion Corp./CR;Attn: J. Robert Brown, 5601 Granite Parkway, Suite 750, Plano, TX, 75024, US

(73) Assignee: RESEARCH IN MOTION LIMITED, Waterloo (CA)

(21) Appl. No.: 12/253,102

(22) Filed: Oct. 16, 2008

(51) Int. Cl. H04M 3/42

(52) U.S. Cl. 455/414.1

(57) ABSTRACT

A method for managing presence information sent from a presentity to a watcher is provided. The method includes the watcher providing watcher information to a presence aspect layer. The method further includes the presence aspect layer determining a manner for providing the presence information to the watcher based on an analysis of the watcher information.

### BACKGROUND

Some user agents (UAs), such as mobile telecommunications devices, can collect presence information associated with the users of the user agents. The presence information might include the user's location, the user's availability, the user's willingness to communicate, the user's willingness to use a particular service or communication method, the user's state of mind, activities the user is currently engaged in, applications currently executing on the user's UA, and similar data that relates to the current state of the user and/or the UA. An entity that has presence information associated with it, such as a human user of a UA, can be referred to as a presentity. A presentity might also be a non-human entity, such as an application executing on a UA. An entity that provides presence information on behalf of one or more presentities can be referred to as a presence source. For example, a UA that provides presence information associated with its user could be a presence source. When a presence source is associated with only one presentity, the presence source and the presentity could be considered equivalent.

A presence source that has collected presence information about a presentity might transmit the presence information to an entity that can be referred to as a presence server. The presence server might then provide the presence information to an entity that wishes to consume the presence information. This entity can be referred to as a watcher. As an example, if a presentity “Bob” has consented to allow other users to have access to information about his current location, Bob's UA might transmit his location information to a presence server. If a watcher “Alice” wished to learn Bob's current location, Alice's UA might submit an appropriate request to the presence server, and the presence server might send presence information about Bob to Alice's UA. Alice's UA might then process the presence information to determine Bob's location.

As used herein, the term “user agent” or “UA” might in some cases refer to a mobile device such as a mobile telephone, a personal digital assistant, a handheld or laptop computer, or a similar device that has telecommunications capabilities. In other cases, the term “UA” might refer to devices that have similar capabilities but that are not transportable, such as fixed line telephones, desktop computers, set-top boxes, or network nodes. The term “UA” can also refer to any hardware or software component that can terminate a communication session, such as a Session Initiation Protocol (SIP) session. Also, the terms “user agent”, “UA”, “user equipment”, “UE”, and “node” might be used synonymously herein.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a block diagram of a communications system according to an embodiment of the disclosure.

FIG. 2 is a block diagram of a communications system according to an alternative embodiment of the disclosure.

FIG. 3 is a flow chart of a method for communicating according to an embodiment of the disclosure.

FIG. 4 is a flow chart of a method for communicating according to an alternate embodiment of the disclosure.

FIG. 5 is a diagram of a wireless communications system including a user agent operable for some of the various embodiments of the disclosure.

FIG. 6 is a block diagram of a user agent operable for some of the various embodiments of the disclosure.

FIG. 7 is a diagram of a software environment that may be implemented on a user agent operable for some of the various embodiments of the disclosure.

FIG. 8 illustrates a processor and related components suitable for implementing the several embodiments of the present disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The present disclosure discusses the use of watcher-related information to control the content and publication of presence-related information. The watcher-related information and presence-related information might be managed by a presence access layer, which will be described in more detail below. The following discussion of presence information in general and the presence access layer in particular may aid in clarifying the subsequent discussion of the control of the publication of presence information via watcher-related information.

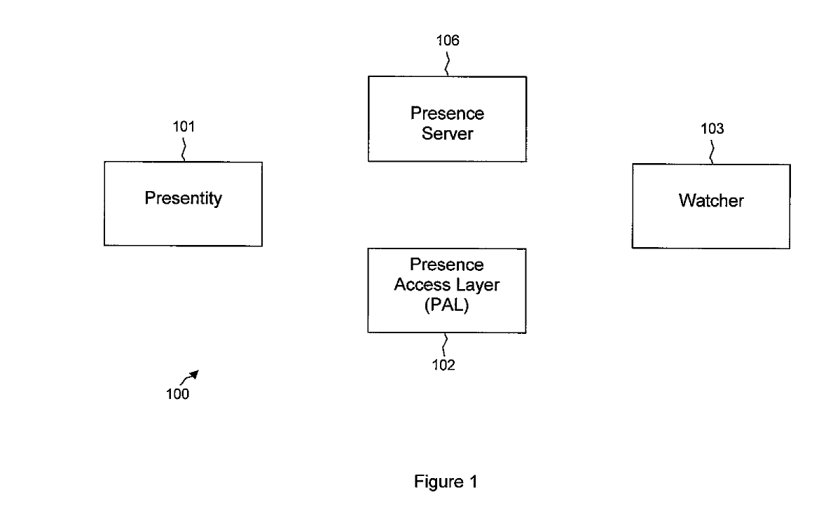

FIG. 1 is a block diagram of an embodiment of a system 100 that includes one or more presentities 101, one or more watchers 103, and a presence server 106. In some cases, a presence access layer (PAL) 102, as described below, might also be present. The PAL 102 might reside wholly or partially in the presence server 106, in the presentity 101, in the watcher 103, in one or more services or applications, and/or in one or more other network components. The functionality provided by the PAL 102 may be divided between these and/or other components. Alternatively, the PAL 102 might be a standalone component.

As mentioned above, the presentity 101 might be a human or non-human entity with which presence information is associated. The presentity 101 might reside wholly or partially on a UA or wholly or partially in a network or on a network component. Although not shown, multiple presence sources that capture presence information on behalf of the presentity 101 might be present. Multiple presentities 101 might also be present, and a single presence source might be associated with multiple presentities 101 and/or a single presentity 101 might be associated with multiple presence sources. Hereinafter, the term “presentity” might refer only to one or more presentities 101 or might refer to one or more presentities 101 and one or more associated presence sources. That is, no distinction will be made between a presentity and a presence source, but it should be understood that in some cases these can be separate entities.

The watcher 103 might be one or more humans, applications, services, or other entities that monitor or wish to consume presence information associated with the presentity 101. When the watcher 103 is an application or a service, the application or service might be wholly or partially resident on a UA. Alternatively, the application or service might be wholly or partially resident on a network component. Hereinafter, the term “watcher” might refer to a human, an application, or a service interested in presence information, to a UA or network component on which such an application or service resides, or to any combination of these entities.

The presentity 101 might be able to define which watchers 103 can receive the presentity's presence information and which presence information the watchers 103 can receive. As an example, the presentity user “Bob” might specify that all of his work supervisors can receive all of his presence information. He might also specify that the watcher “Alice” can receive information about his current willingness to communicate but can receive none of his other presence information, such as his current location. Alternatively, another entity, such as Bob's employer, might designate which elements of Bob's presence information will be made available to which watchers 103.

A plurality of applications or services, such as instant messaging services or push-to-talk services, might be associated with the presentity 101, and these applications or services might be provided by one or more devices. The presentity 101 might publish presence information from a plurality of these devices. For example, Bob might be using a desktop computer and a handheld telephone simultaneously and may be considered available on either device. If Bob did not use the computer for an extended period of time, the computer might enter a sleep mode, and Bob might become unavailable on that device. However, he might remain available on the handset.

The presentity 101 can publish its presence information to the presence server 106. Only certain portions of the presence information might be made available to the watchers 103, and only certain watchers 103 might have access to the presence information. The presentity 101 or a third party (for example, a service provider or administrator) might publish rules or policies to the presence server 106 that define the portions of the presence information that will be made available to the watchers 103 and which of the portions will be made available to which of the watchers 103. The rules or polices might be established for groups of presentities 101 and/or groups of watchers 103. The rules or polices might be provided to the presence server 106 in a policy document. Alternatively, the presence information that will be made available to a particular watcher 103 might be determined at the time that watcher 103 requests presence information.

As used herein, the term “rule” refers to a sequence of logic that, when executed, can specify actions. The term “policy” refers to logic that can aid in the evaluation of a rule by, for example, providing hints, clarifying indeterminate or inconclusive scenarios during processing, or providing parameters. A distinction might also be made between a rule and a base rule and between a policy and a base policy. A base rule is typically a common interoperable rule or a default rule. That is, a base rule is a rule that is specified when no specific service or platform has overridden or changed it. Therefore, the term “rule” could refer to any rule, base or otherwise. Similarly, the term “policy” could refer to the set of all policies, and the term “base policy” could refer to a common or default policy that is used when a policy has not been overridden, extended, or enhanced.

The presence server 106 is a network component that receives presence information from the presentity 101 and provides presence information to the watcher 103. The rules or policies that define the presence information that will be made available to the watchers 103 might be stored on and/or processed by the presence server 106. When the watcher 103 wishes to receive presence information associated with the presentity 101, the watcher 103 can send a request to the presence server 106. The presence server 106 can then determine if the watcher 103 is authorized to receive the presentity's presence information. If the watcher 103 is authorized, the presence server 106 sends the presence information to the watcher 103.

The presence information might be sent to the watcher 103 in a Presence Information Data Format (PIDF). Alternatively, more detailed information might be provided if the rich presence extension to PIDF (RPID) is used. In either case, the presence information might be provided in a presence document that can be encoded in extensible markup language (XML) or another appropriate format. The presence document is typically a large document that contains all of the presence information that the presentity 101 has allowed the watcher 103 to obtain. That is, even when the watcher 103 wants to learn only a single element of presence information, such as the presentity's current willingness to communicate, the presence document might contain numerous additional elements of presence information.

Upon receiving the presence document, the watcher 103 parses the XML or other encoding scheme to extract the desired presence information. The entire presence document is typically parsed, regardless of the amount of presence information that is sought. For example, if the watcher 103 wished to learn the presentity's current willingness to communicate, the watcher 103 might need to sift through large amounts of unrelated data, such as the presentity's location, the presentity's willingness to use a particular service, the applications currently executing on the presentity's UA, and other information, to find the single data element that is desired.

In some cases, the watcher 103 might wish to learn a combination of information about the presentity 101. For example, if the watcher 103 wanted to send an instant message to the presentity 101, the watcher 103 might first attempt to determine the presentity's willingness to communicate and whether an instant messaging application is currently executing on the presentity's UA. In such cases, the watcher 103 might again send a single request for presence information to the presence server 106 and might again receive the entire presence document. The watcher 103 would then parse the entire document to find the plurality of data elements that are desired and perform the appropriate logical operations to correlate the data elements and derive the combination of information that was desired.

It may be possible that the presentity 101 did not specify whether or not the watcher 103 could have access to a data element that the watcher 103 is trying to obtain. In that case, the presence document may not contain the information that the watcher 103 is seeking. In such a case, the results of the watcher's parsing of the presence document may be indeterminate and it may not be clear what further actions the watcher 103 should take.

In some cases, the PAL 102 might be present to promote more efficient processing and dissemination of presence information. The PAL 102 can abstract and simplify complex presence information on behalf of the watcher 103. That is, the PAL 102 can act as a proxy for the watcher 103 by receiving a presence information request from the watcher 103, sending the request to the presence server 106, receiving a presence document from the presence server 106, parsing the information in the presence document, and returning to the watcher 103 a single value, such as “true” or “false”, as a response to the presence information request.

The PAL 102 allows the watcher 103 to submit a request for a single element of presence information, which can be referred to as a presence aspect. For example, the presentity's willingness to communicate might be a presence aspect, the presentity's current location might be another, the presentity's preferred means of communication might be another, and so on. The presence aspects are reusable, interoperable abstractions that can be applicable across a plurality of applications or services. The watcher 103 can send a message to the PAL 102 specifying a single presence aspect for which the watcher 103 is seeking information. The PAL 102 can then respond with information related only to that presence aspect.

As an example, if the watcher 103 wishes to learn whether the presentity 101 is currently willing to communicate, the watcher 103 can submit a request to the PAL 102 for information specifically about that presence aspect. If the presentity 101 has specified that the watcher 103 can have access to the presentity's willingness information, the PAL 102 can respond with a single value indicating the presentity's willingness or unwillingness to communicate. The watcher 103 then needs to process only this single value. This can be contrasted with the situation where the PAL 102 is not present. In that case, the watcher 103 would ask for presence information in general, receive the entire presence document, and parse the presence document to determine the willingness aspect.

The PAL 102 can also process more complex requests from the watcher 103. For example, if the watcher 103 wished to determine a combination of information associated with the presentity 101, the watcher 103 might send the PAL 102 a request for each desired presence aspect. The PAL 102 might then return a response for each of the requests. Alternatively, the PAL 102 might correlate multiple presence aspects and return a single value to the watcher 103 that represents the combination of information that the watcher 103 was seeking.

In addition to greatly simplifying the manner in which the watcher 103 requests, receives, and processes presence information, use of the PAL 102 can allow processing that might previously have been performed by the watcher 103 to be offloaded to the PAL 102. In the cases where the PAL 102 is a standalone component or resides wholly or partially in the presence server 106 or some other network component, offloading the processing of presence information to the PAL 102 can free some of the processing capabilities of the watcher 103 for other purposes.

The PAL 102 may also process presence information on behalf of multiple applications or services that might otherwise redundantly perform the same presence information processing. That is, multiple applications or services might reside on or be available to the watcher 103, and each might have the capability to request, receive, and process presence information. Many of the steps that the applications or services take with regard to the presence information might be common to several of the applications or services. For example, there may be common presence-related rules or logic that would apply to both an instant messaging service and a push-to-talk service. If the PAL 102 is not present, each of these services might perform the common steps separately. If the PAL 102 is present, the PAL 102 can perform the common steps on behalf of each of these services and then return the results of the processing to the services. This can allow common procedures to occur only one time, thus increasing the efficiency of the watcher 103 and the applications or services it uses.

The PAL 102 can also ensure that indeterminate results are not returned to the watcher 103. As mentioned previously, if the watcher 103 seeks information about a presence aspect for which the presentity 101 has not provided information, the watcher's parsing of the presence document to determine that information might be inconclusive. The PAL 102, however, can contain functionality that specifies a definitive response to a presence information request even when information about the requested presence aspect is not available. For example, if the presentity 101 has not specified a willingness or an unwillingness to communicate, and if the watcher 103 submits a request for the presentity's willingness presence aspect, the PAL 102 might provide a default willingness value to the watcher 103. For instance, the PAL 102 might indicate that the presentity 101 is unwilling to communicate for an indefinite period of time. In this way, the watcher 103 can be assured of receiving a usable response to any presence information request.

While the above discussion has focused on the PAL 102 providing presence information to the watcher 103 in response to the watcher's request for the current status of that information, the PAL 102 might also provide presence information based on a trigger defined by the watcher 103. That is, the watcher 103 might specify that it wishes to be informed when a change occurs in a presence aspect. When the PAL 102 detects that the specified change has occurred, the PAL 102 can notify the watcher 103 of the change. A trigger might apply to a presence aspect alone or to a presence aspect in combination with one or more applications or services. In addition, a trigger might be used to receive presence information from a plurality of presentities 101 and/or to provide presence information to a plurality of watchers 103.

As an example, the watcher 103 might have previously determined that the presentity's willingness presence aspect has a value that indicates that the presentity 101 is currently unwilling to communicate. The watcher 103 might wish to know if the presentity 101 becomes willing to communicate at a later point in time. The watcher 103 could establish a trigger on the PAL 102 requesting to be notified of a change in the presentity's willingness presence aspect. The PAL 102 would then monitor the presentity's willingness presence aspect and would inform the watcher 103 if that presence aspect changed from “unwilling” to “willing”.

The use of the PAL 102 does not necessarily preclude the presence server 106 sending the presence document to the watcher 103. For example, if the watcher 103 wishes to obtain a large amount of presence information, there may be circumstances in which it is more efficient for the watcher 103 to parse the entire presence document received from the presence server 106 rather than processing multiple individual presence aspect values received from the PAL 102. The PAL 102 provides an upgrade option that might be used to hide complexity from the watcher 103 in some circumstances.

The above discussion was intended to provide sufficient information to promote an understanding of presence information in general and the presence access layer in particular. With this context in place, the discussion can now turn to the use of watcher information to control or limit presence publications from a presence source or presence user agent (PUA) on behalf of a presentity.

The term “watcher information” can refer to any information about one or more watchers that can be provided to a presentity. For example, watcher information might include the identities of the watchers that are requesting the presentity's presence information, the number of watchers that are requesting the presentity's presence information, and general information about the types of presence information that the watchers are typically interested in. In an embodiment, as described in more detail below, watcher information can be extended to include a level of interest a watcher has toward an element of presence information, a level of acquaintance a watcher has toward a presentity, and other, more specific information.

In an embodiment, the PAL can use such watcher information to control the content of the presence information that a presentity provides to one or more watchers and the frequency with which the presence information is provided. As mentioned previously, a presentity provides its presence information to the PAL in a presence document that might contain all of the presence information related to the presentity. The PAL can then parse the presence document and return only selected portions of the presence information to a watcher. However, the entire presence document is still passed from the presentity to the PAL. Transmitting such a large document can consume excessive bandwidth, storage capacity, and processing overhead.

In an embodiment, the PAL can reduce the consumption of such resources by determining which portions of presence information are to be included in the presence document and how often the presence document is to be transmitted. That is, the PAL can analyze the requests for presence aspects or triggered presence aspects on behalf of one or more watchers, along with calculating the quantity of watchers for a given presentity, to determine the types of presence information that one or more watchers are interested in and the levels of interest the watchers have in the presence information and in the presentity. The PAL can then reflect this analysis toward the presentity through different mechanisms (e.g., through extended watcher information sent to the presentity) such that the resulting presence document(s) published by the presentity are edited in accordance with this analysis of the watcher information. The presentity might then transmit an edited presence document that contains only the information for which a watcher has expressed an interest. Alternatively or in addition, if no watchers are highly interested in the presentity's presence information, the presentity might reduce the frequency with which it transmits the presence document. Bandwidth, storage capacity, and processing overhead can thus be reduced.

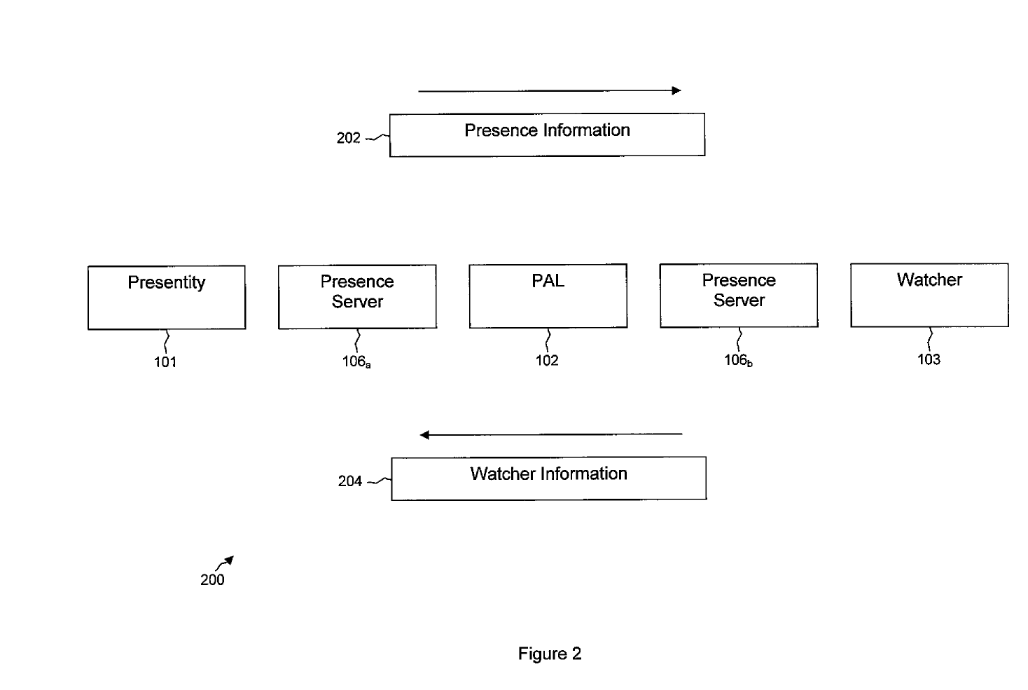

FIG. 2 illustrates an embodiment of a communications system 200 that might implement the PAL 102. FIG. 2 is exemplary and may have other components or arrangements in other embodiments. The system 200 includes the presentity 101, the PAL 102, one or more watchers 103, and one or more presence servers 106, as previously discussed with regard to FIG. 1. The presentity 101 might include or otherwise have access to a UA or a service that can convey presence-related information 202 via the PAL 102 to the watcher 103. The watcher 103 might include or otherwise have access to a UA or a service that can convey watcher-related information 204 via the PAL 102 to the presentity 101.

The watcher information 204 might include information that is traditionally considered watcher information, such as the quantities and identities of the watchers 103 that are requesting and/or subscribing to the presentity's presence information and the types of presence information that the watchers 103 are typically interested in. In an embodiment, the watcher information 204 can be extended to include additional information. Specifically, the watcher information 204 can include a graded level of interest that the watcher 103 has in an element of presence information 202 and a graded level of acquaintance that the watcher 103 feels or reflects toward the presentity 101. The watcher 103 might grade the levels using percentages, numerical rankings, keywords, enumerators, or other means of providing relative assessments of importance. For example, the watcher 103 might assign a relatively high level of interest to an element of presence information 202 that is important to the watcher 103 and might assign a relatively low level of interest to an element of presence information 202 that is typically unimportant to the watcher 103. Similarly, the watcher 103 might assign a relatively high level of acquaintance to a presentity 101 who is a close friend or a member of the watcher's work group and might assign a relatively low level of acquaintance to a casual acquaintance or a distant work associate.

It is also possible that, in addition to the watcher 103 providing watcher information 204, a given service, operating independently of the watcher 103, may include or incorporate watcher information 204 toward the presentity 101. This information could include, for example, the presence information that a particular service will use. The PAL 102 may use rules to provide a combined indication of service-related watcher information, based on a single service, an aggregation of services, and/or a class of service. This mechanism could be combined with individual watcher preferences to provide a ‘combined view’ of what the presentity 101 should publish.

The watcher 103 might provide watcher information 204 to the PAL 102 at approximately the time the watcher 103 sends the PAL 102 a request for an element of presence information 202. Alternatively, the watcher 103 might provide the watcher information 204 to the PAL 102 prior to sending such a request, and the PAL 102 might store the watcher information 204 for future use.

Since the PAL 102 can act as a proxy for multiple watchers 103, the PAL 102 might have watcher information 204 from one or more watchers 103 that relates to a single presentity 101. The PAL 102 can analyze the watcher information 204 from the multiple sources to determine how the presentity's presence document might be handled to most efficiently accommodate the preferences and other characteristics of all of the watchers 103.

In some cases, the PAL 102 might perform an analysis of the watcher information 204 upon receiving an instruction from the presentity 101 to do so. That is, upon being notified that the watcher 103 has requested presence information 202, the presentity 101 might determine the presence information 202 that it will provide to the watcher 103 by requesting that the PAL 102 analyze the watcher's watcher information 204. Alternatively, the presentity 101 might request the PAL 102 to perform an analysis of the watcher information 204 from a plurality of watchers 103, and the results of the analysis might apply to all of the watchers 103. When one of the watchers 103 requests the presentity's presence information 202, the presence information 202 that is returned to the watcher 103 might be based on this aggregated analysis. Alternatively, the PAL 102 might perform the analysis of the watcher information 204 without receiving any input from the presentity 101.

The results of the analysis (based on PAL rules and policies) can be exposed to the presentity 101 as extended watcher information presence aspects. The watcher information presence aspects are similar to the previously discussed presence aspects, with the exception that the watcher information presence aspects are directed toward a watcher information subscriber (which is typically the presentity 101, but may be another entity). Therefore, the presentity ‘Bob’ can request a watcher information presence aspect associated with the watcher ‘Alice’, just as the watcher ‘Alice’ could request a standard presence aspect (e.g., ‘willingness’) associated with the presentity ‘Bob’. An example of a watcher information presence aspect might be ‘watcher-quantity’, which would tell the presentity 101 how many discrete watchers 103 are watching the presentity 101. The watcher information presence aspects might include a list of the Address of Record/identity of each watcher 103.

In an embodiment, at least a portion of the PAL 102 might be co-located with the presentity 101. This portion of the PAL 102, which can be referred to as a PAL agent, can implement the determination made by the other portions of the PAL 102 regarding the handling of the presentity's presence document. That is, the other portions of the PAL 102 might send the PAL agent instructions on how the presentity's presence document is to be edited and how often the presentity's presence document is to be transmitted. The PAL agent can then interact with the presentity 101 to ensure that the presentity's presence document is handled in the manner determined by the analysis of the watcher information 204. Alternatively, the entire functionality of the PAL 102 could be co-located with the presentity 101 or none of the functionality of the PAL 102 could be co-located with the presentity 101.

In an embodiment, the PAL 102 might consider the preferences of the presentity 101 in performing the analysis of the watcher information 204. That is, just as the watcher 103 can specify a graded level of interest in receiving an element of presence information 202 and a graded level of acquaintance toward the presentity 101, the presentity 101 can specify a graded level of interest in sending an element of presence information 202 and a graded level of acquaintance toward one or more watchers 103. The presentity 101 might assign a relatively high level of interest to presence information 202 that the presentity 101 feels the watchers 103 should receive and a relatively low level of interest to presence information 202 that the presentity 101 feels is of less importance to the watchers 103. Similarly, the presentity 101 might assign a relatively high level of acquaintance to a watcher 103 who is a close friend or a member of the presentity's work group and might assign a relatively low level of acquaintance to a casual acquaintance or a distant work associate. The PAL 102 can then combine these presentity preferences with the watcher information 204 to further refine the information that is included in the presentity's presence document and the frequency with which the presence document is transmitted.

In addition to the presentity 101 and the watcher 103 providing such information, a service or combination of services might reflect a ‘grading scheme’. For example, an instant messaging service might grade certain elements of presence information, such as opt-in, willingness, or availability, higher than other elements of presence information, such as mood or activity. Further, these service-related grades could be combined by the PAL 102 with other information to establish an aggregate view of an appropriate level of information that the presentity 101 should publish. This logic could also apply to a group or a sphere of users.

As an example, the PAL's analysis of the watcher information 204 might determine that there are no watchers 103 interested in a particular element of the presentity's presence information 202. The PAL 102 could then ensure that that element of presence information 202 is not included in the presentity's presence document. In another example, if the PAL 102 determines that there are no watchers 103 interested in any of the presentity's presence information 202, the PAL 102 might ensure that the presence document is not transmitted at all.

In yet another example, the PAL 102 might determine that all of the watchers 103 are only mildly interested in the presentity's presence information 202. The PAL 102 might then cause a decrease in the frequency with which the presence document is transmitted. Alternatively, some of the watchers 103 might be highly interested in the presentity's presence information 202 and some might be less interested. The PAL 102 might maintain a relatively high frequency for transmitting the presence document to the more interested watchers 103 might cause a decrease in the frequency for transmitting the presence document to the less interested watchers 103.

In still another example, if the PAL 102 determines that the presentity 101 does not consider any of the watchers 103 to be close acquaintances, the PAL 102 might cause a decrease in the frequency with which the presence document is transmitted. Alternatively, the presentity 101 might consider some of the watchers 103 to be close acquaintances and some to be more distant acquaintances. The PAL 102 might maintain a relatively high frequency for transmitting the presence document to the close acquaintances and might cause a decrease in the frequency for transmitting the presence document to the distant acquaintances.

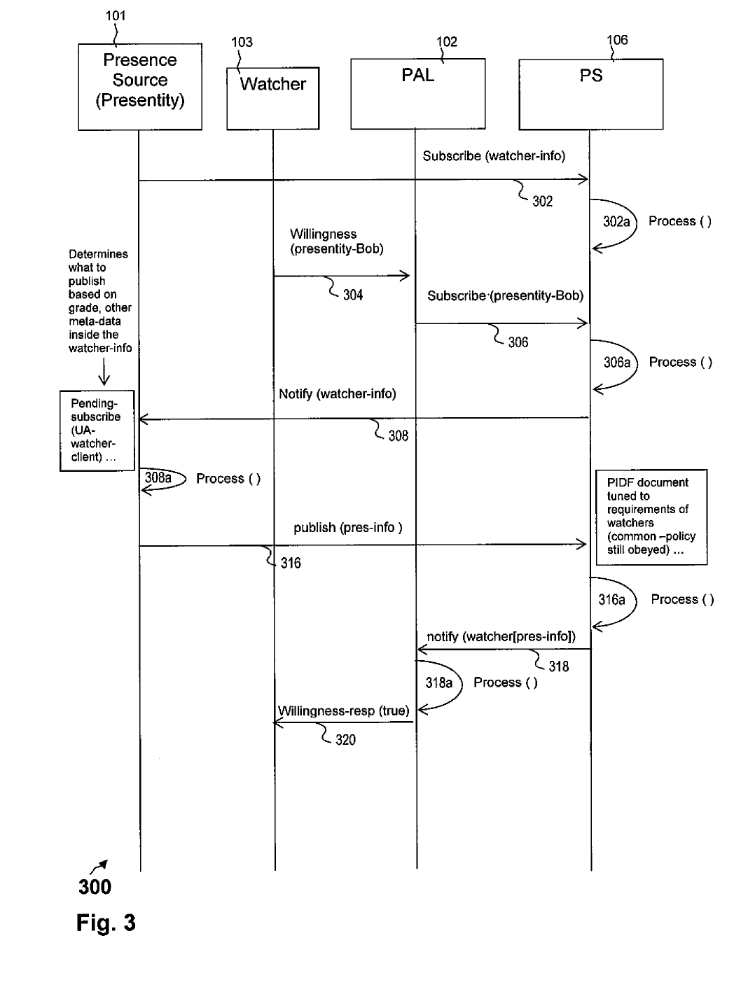

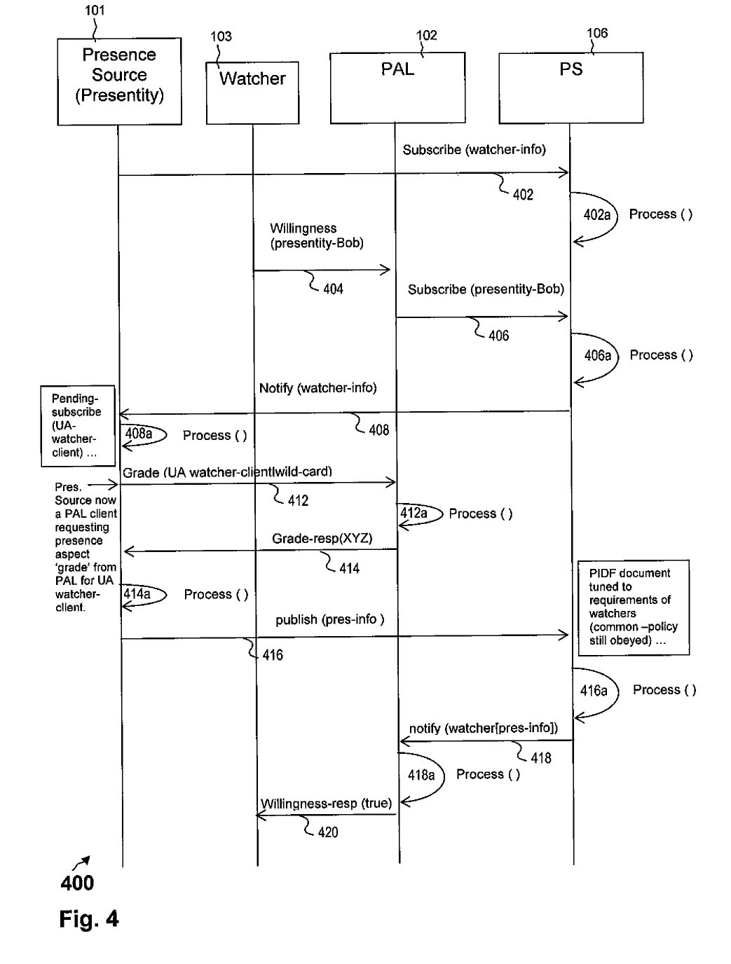

FIGS. 3 and 4 illustrate examples of message flows for controlling the publication of presence information via watcher information from the watcher 103. FIGS. 3 and 4 are exemplary and other flow charts and procedures could be used.

In FIG. 3, at event 302, the presentity 101 submits a message to the presence server 106 requesting watcher information. The message may be in the form of a subscribe message, such as a Session Initiation Protocol (SIP) Subscribe message, that might include one or more instructions configured to request the watcher information. At event 302a, the presence server 106 processes the request for the watcher information.

At event 304, the watcher 103 requests an element of the presentity's presence information from the PAL 102. In this example, the watcher 103 wishes to learn the presentity's willingness to communicate. At event 306, the PAL 102 sends a message to the presence server 106 relaying the watcher's request. The message might be in the form of a SIP Subscribe message, for example. At event 306a, the presence server 106 processes the SIP Subscribe message.

At event 308, the presence server 106 sends a message to the presentity 101 conveying the watcher's watcher information. The message might be in the form of a SIP Notify message, for example. At event 308a, the presentity 101 processes the watcher information in the notification message to determine what presence information to publish to the watcher 103 and how often to publish the presence information. The determination might be based on a grade of the watcher's interest level in the presence information or acquaintance level with the presentity 101 or on other watcher-related or presentity-specified information. The presentity 101 might employ a co-located portion of the PAL 102 to perform and implement the analysis 308a of the watcher information.

At event 316, the presentity 101 publishes the presence information to the presence server 106. Based upon the analysis of the watcher information, the presence publication is tuned to the preferences of the watcher 103. That is, the presentity's presence document might be smaller than it otherwise would have been or might be published less often than it otherwise would have been. When the presence server 106 receives the tuned presence publication, the presence server 106 processes the publication at event 316a.

At event 318, the presence server 106 sends a message to the PAL 102 containing the tuned presence information. The PAL 102 processes the tuned presence publication at event 318a to derive a “willingness” presence aspect. At event 320, the PAL 102 sends the watcher 103 a message indicating the willingness of the presentity 101 to communicate.

FIG. 4 illustrates an example of an alternative message flow for controlling the publication of presence information. In an embodiment, the events 402, 402a, 404, 406, 406a, 408, 408a, 416, 416a, 418, 418a, and 420 of FIG. 4 may be similar to the events 302, 302a, 304, 306, 306a, 308, 308a, 316, 316a, 318, 318a, and 320 of FIG. 3. Additional events as discussed below provide alternative steps in managing and limiting presence information publications via the PAL 102.

At event 412, the presentity 101 requests the PAL 102 to determine an aggregate grade for all of the presentity's current watchers 103. That is, the presentity 101 instructs the PAL 102 to consider the levels of interest and/or acquaintance of all of the watchers 103 and derive or compute an interest and/or acquaintance grade that can apply to all of the watchers 103. The presentity 101 can then use this aggregate grade to determine the presence information that it will send to all of its current watchers 103. In this way, the presentity 101 can avoid sending a separate request for watcher information each time one of the watchers 103 requests presence information.

The PAL 102 processes the presentity's request for an aggregate grade at event 412a, and, at event 414, the PAL 102 returns the aggregate grade to the presentity 101. At event 414a, the presentity 101 uses the aggregate grade to establish the content and publication frequency for the presence document that it will publish.

Alternatively, it is possible for the presentity 101 to entirely circumvent the normal watcher information subscription scheme outlined in steps 402, 408, and 408a. The presentity 101 could choose to simply request all watcher information and extended watcher information as watcher information presence aspects. In such a case, the PAL 102 would subscribe to watcher information (as detailed in step 402) on behalf of the presentity 101, and the PAL 102 would receive and process the ‘base’ watcher information data sent by the presence server 106 (in steps 408 and 408a). The PAL 102 would then be able to provide watcher information results to the presentity 101 as a response to either a watcher information presence aspect request (such as ‘who-is-subscribing-to-me’) or an extended watcher information presence aspect request (such as ‘watcher-quantity’).

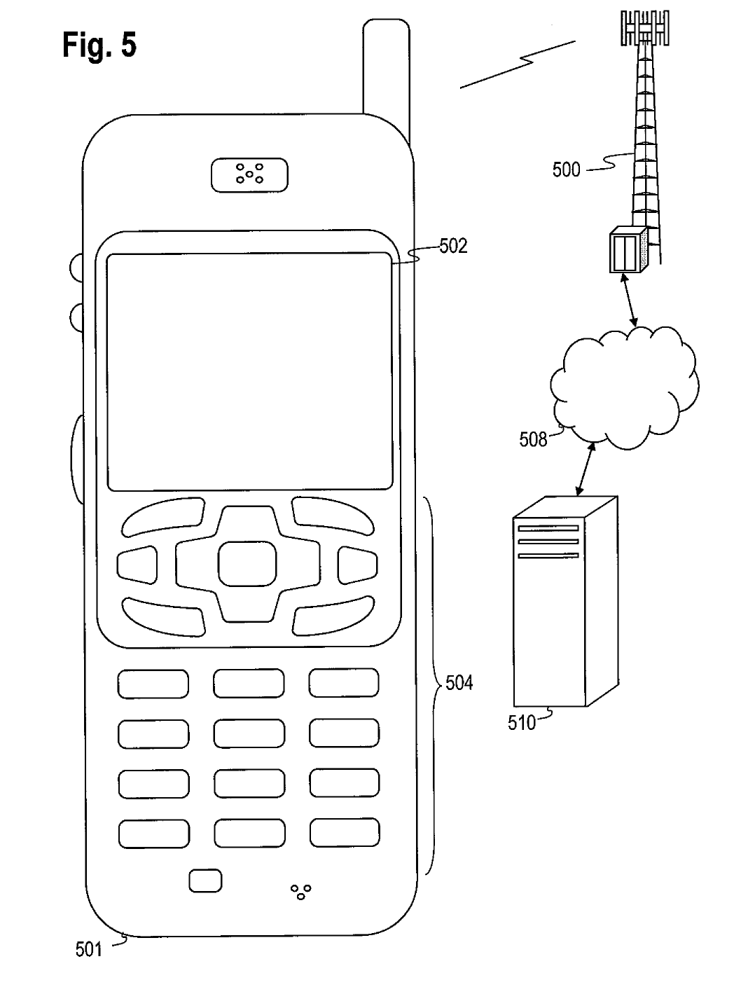

FIG. 5 illustrates a wireless communications system including an embodiment of a UA 501. The UA 501 is operable for implementing aspects of the disclosure, but the disclosure should not be limited to these implementations. Though illustrated as a mobile phone, the UA 501 may take various forms including a wireless handset, a pager, a personal digital assistant (PDA), a portable computer, a tablet computer, or a laptop computer. Many suitable devices combine some or all of these functions. In some embodiments of the disclosure, the UA 501 is not a general purpose computing device like a portable, laptop or tablet computer, but rather is a special-purpose communications device such as a mobile phone, a wireless handset, a pager, a PDA, or a telecommunications device installed in a vehicle. In another embodiment, the UA 501 may be a portable, laptop or other computing device. The UA 501 may support specialized activities such as gaming, inventory control, job control, and/or task management functions, and so on.

The UA 501 includes a display 502. The UA 501 also includes a touch-sensitive surface, a keyboard or other input keys generally referred as 504 for input by a user. The keyboard may be a full or reduced alphanumeric keyboard such as QWERTY, Dvorak, AZERTY, and sequential types, or a traditional numeric keypad with alphabet letters associated with a telephone keypad. The input keys may include a trackwheel, an exit or escape key, a trackball, and other navigational or functional keys, which may be inwardly depressed to provide further input function. The UA 501 may present options for the user to select, controls for the user to actuate, and/or cursors or other indicators for the user to direct.

The UA 501 may further accept data entry from the user, including numbers to dial or various parameter values for configuring the operation of the UA 501. The UA 501 may further execute one or more software or firmware applications in response to user commands. These applications may configure the UA 501 to perform various customized functions in response to user interaction. Additionally, the UA 501 may be programmed and/or configured over-the-air, for example from a wireless base station, a wireless access point, or a peer UA 501.

Among the various applications executable by the UA 501 are a web browser, which enables the display 502 to show a web page. The web page may be obtained via wireless communications with a wireless network access node, a cell tower, a peer UA 501, or any other wireless communication network or system 500. The network 500 is coupled to a wired network 508, such as the Internet. Via the wireless link and the wired network, the UA 501 has access to information on various servers, such as a server 510. The server 510 may provide content that may be shown on the display 502. Alternately, the UA 501 may access the network 500 through a peer UA 501 acting as an intermediary, in a relay type or hop type of connection.

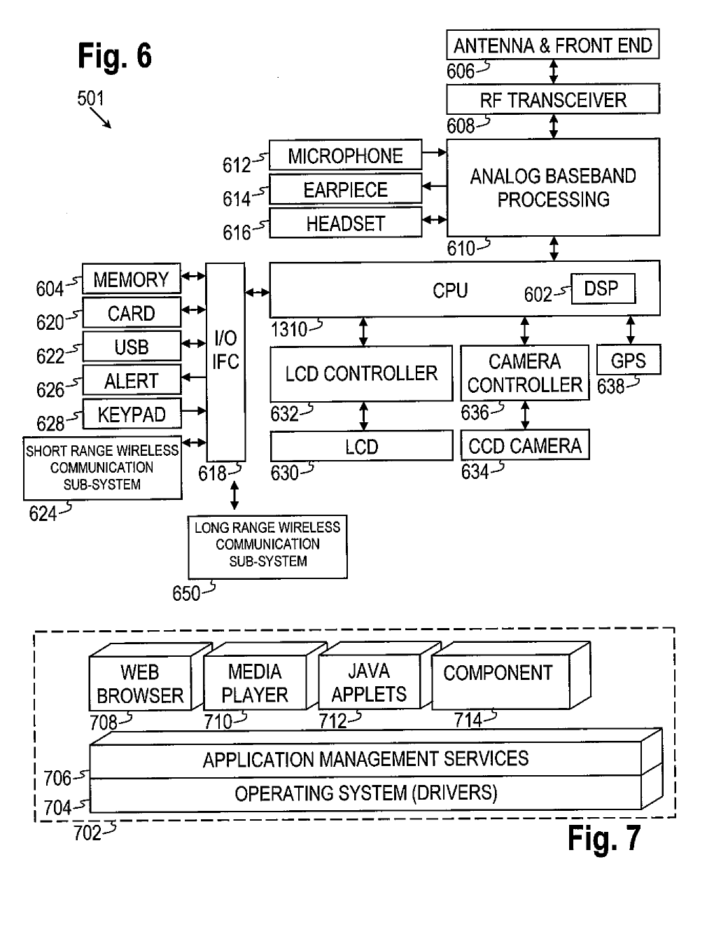

FIG. 6 shows a block diagram of the UA 501. While a variety of known components of UAs 501 are depicted, in an embodiment a subset of the listed components and/or additional components not listed may be included in the UA 501. The UA 501 includes a memory 604 and a central processing unit (CPU) 1310 that may incorporate a digital signal processor (DSP) 602. As shown, the UA 501 may further include an antenna and front end unit 606, a radio frequency (RF) transceiver 608, an analog baseband processing unit 610, a microphone 612, an earpiece speaker 614, a headset port 616, an input/output interface 618, a removable memory card 620, a universal serial bus (USB) port 622, a short range wireless communication sub-system 624, an alert 626, a keypad 628, a liquid crystal display (LCD), which may include a touch sensitive surface 630, an LCD controller 632, a charge-coupled device (CCD) camera 634, a camera controller 636, and a global positioning system (GPS) sensor 638. In an embodiment, the UA 501 may include another kind of display that does not provide a touch sensitive screen. In an embodiment, the DSP 602 may communicate directly with the memory 604 without passing through the input/output interface 618.

The DSP 602 or some other form of controller or central processing unit operates to control the various components of the UA 501 in accordance with embedded software or firmware stored in memory 604 or stored in memory contained within the DSP 602 itself. In addition to the embedded software or firmware, the DSP 602 may execute other applications stored in the memory 604 or made available via information carrier media such as portable data storage media like the removable memory card 620 or via wired or wireless network communications. The application software may comprise a compiled set of machine-readable instructions that configure the DSP 602 to provide the desired functionality, or the application software may be high-level software instructions to be processed by an interpreter or compiler to indirectly configure the DSP 602.

The antenna and front end unit 606 may be provided to convert between wireless signals and electrical signals, enabling the UA 501 to send and receive information from a cellular network or some other available wireless communications network or from a peer UA 501. In an embodiment, the antenna and front end unit 606 may include multiple antennas to support beam forming and/or multiple input multiple output (MIMO) operations. As is known to those skilled in the art, MIMO operations may provide spatial diversity which can be used to overcome difficult channel conditions and/or increase channel throughput. The antenna and front end unit 606 may include antenna tuning and/or impedance matching components, RF power amplifiers, and/or low noise amplifiers.

The RF transceiver 608 provides frequency shifting, converting received RF signals to baseband and converting baseband transmit signals to RF. In some descriptions a radio transceiver or RF transceiver may be understood to include other signal processing functionality such as modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions. For the purposes of clarity, the description here separates the description of this signal processing from the RF and/or radio stage and conceptually allocates that signal processing to the analog baseband processing unit 610 and/or the DSP 602 or other central processing unit. In some embodiments, the RF Transceiver 608, portions of the Antenna and Front End 606, and the analog baseband processing unit 610 may be combined in one or more processing units and/or application specific integrated circuits (ASICs).

The analog baseband processing unit 610 may provide various analog processing of inputs and outputs, for example analog processing of inputs from the microphone 612 and the headset 616 and outputs to the earpiece 614 and the headset 616. To that end, the analog baseband processing unit 610 may have ports for connecting to the built-in microphone 612 and the earpiece speaker 614 that enable the UA 501 to be used as a cell phone. The analog baseband processing unit 610 may further include a port for connecting to a headset or other hands-free microphone and speaker configuration. The analog baseband processing unit 610 may provide digital-to-analog conversion in one signal direction and analog-to-digital conversion in the opposing signal direction. In some embodiments, at least some of the functionality of the analog baseband processing unit 610 may be provided by digital processing components, for example by the DSP 602 or by other central processing units.

The DSP 602 may perform modulation/demodulation, coding/decoding, interleaving/deinterleaving, spreading/despreading, inverse fast Fourier transforming (IFFT)/fast Fourier transforming (FFT), cyclic prefix appending/removal, and other signal processing functions associated with wireless communications. In an embodiment, for example in a code division multiple access (CDMA) technology application, for a transmitter function the DSP 602 may perform modulation, coding, interleaving, and spreading, and for a receiver function the DSP 602 may perform despreading, deinterleaving, decoding, and demodulation. In another embodiment, for example in an orthogonal frequency division multiplex access (OFDMA) technology application, for the transmitter function the DSP 602 may perform modulation, coding, interleaving, inverse fast Fourier transforming, and cyclic prefix appending, and for a receiver function the DSP 602 may perform cyclic prefix removal, fast Fourier transforming, deinterleaving, decoding, and demodulation. In other wireless technology applications, yet other signal processing functions and combinations of signal processing functions may be performed by the DSP 602.

The DSP 602 may communicate with a wireless network via the analog baseband processing unit 610. In some embodiments, the communication may provide Internet connectivity, enabling a user to gain access to content on the Internet and to send and receive e-mail or text messages. The input/output interface 618 interconnects the DSP 602 and various memories and interfaces. The memory 604 and the removable memory card 620 may provide software and data to configure the operation of the DSP 602. Among the interfaces may be the USB interface 622 and the short range wireless communication sub-system 624. The USB interface 622 may be used to charge the UA 501 and may also enable the UA 501 to function as a peripheral device to exchange information with a personal computer or other computer system. The short range wireless communication sub-system 624 may include an infrared port, a Bluetooth interface, an IEEE 802.11 compliant wireless interface, or any other short range wireless communication sub-system, which may enable the UA 501 to communicate wirelessly with other nearby mobile devices and/or wireless base stations. A long range wireless communication sub-system 650 may also be present and may be compliant with IEEE 802.16.

The input/output interface 618 may further connect the DSP 602 to the alert 626 that, when triggered, causes the UA 501 to provide a notice to the user, for example, by ringing, playing a melody, or vibrating. The alert 626 may serve as a mechanism for alerting the user to any of various events such as an incoming call, a new text message, and an appointment reminder by silently vibrating, or by playing a specific pre-assigned melody for a particular caller.

The keypad 628 couples to the DSP 602 via the interface 618 to provide one mechanism for the user to make selections, enter information, and otherwise provide input to the UA 401. The keyboard 628 may be a full or reduced alphanumeric keyboard such as QWERTY, Dvorak, AZERTY and sequential types, or a traditional numeric keypad with alphabet letters associated with a telephone keypad. The input keys may include a trackwheel, an exit or escape key, a trackball, and other navigational or functional keys, which may be inwardly depressed to provide further input function. Another input mechanism may be the LCD 630, which may include touch screen capability and also display text and/or graphics to the user. The LCD controller 632 couples the DSP 602 to the LCD 630.

The CCD camera 634, if equipped, enables the UA 501 to take digital pictures. The DSP 602 communicates with the CCD camera 634 via the camera controller 636. In another embodiment, a camera operating according to a technology other than Charge Coupled Device cameras may be employed. The GPS sensor 638 is coupled to the DSP 602 to decode global positioning system signals, thereby enabling the UA 501 to determine its position. Various other peripherals may also be included to provide additional functions, e.g., radio and television reception.

FIG. 7 illustrates a software environment 702 that may be implemented by the DSP 602. Alternatively, the software environment 702 can be executed in an execution environment hosted by the central processing unit (CPU) 1310 on the UA 501 or by a logical CPU 1310 with a combined DSP 602 function. The DSP 602 executes operating system drivers 704 that provide a platform from which the rest of the software operates. The operating system drivers 704 provide drivers for the node hardware with standardized interfaces that are accessible to application software. The operating system drivers 704 include application management services (“AMS”) 706 that transfer control between applications running on the UA 501, monitor applications, preempt applications, and perform other functions of an underlying operating system platform such as controlling, monitoring, and sometimes preempting or terminating logical processes, including execution threads.

Also shown in FIG. 7 are a web browser application 708, a media player application 710, and Java applets 712. The web browser application 708 configures the UA 501 to operate as a web browser, allowing a user to enter information into forms and select links to retrieve and view web pages. The media player application 710 configures the UA 501 to retrieve and play audio or audiovisual media. The Java applets 712 configure the UA 501 to provide games, utilities, and other functionality. The AMS 706 may also host a Java Virtual Machine on which the Java applets 712 can execute. Other execution environments could also be hosted, such as a C runtime environment to support executable programs and applications written in the C programming language. A component 714 might provide functionality related to publication of presence information.

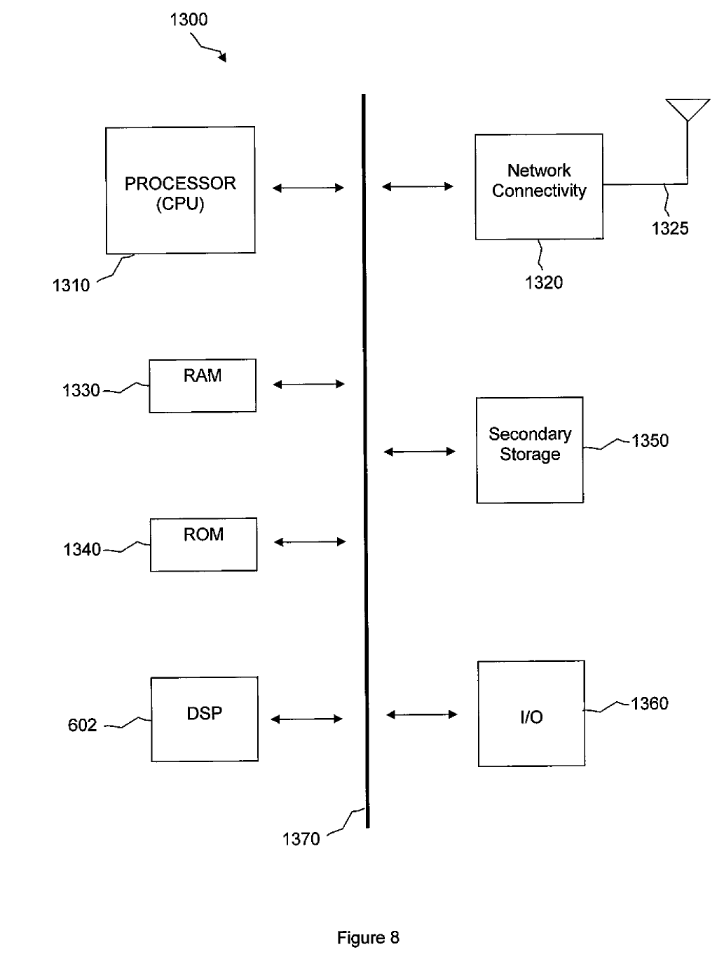

The UA 501 and other components described above might include a processing component that is capable of executing instructions related to the actions described above. FIG. 8 illustrates an example of a system 1300 that includes a processing component 1310 suitable for implementing one or more embodiments disclosed herein. In addition to the processor 1310 (which may be referred to as a central processor unit or CPU), the system 1300 might include network connectivity devices 1320, random access memory (RAM) 1330, read only memory (ROM) 1340, secondary storage 1350, and input/output (I/O) devices 1360. These components might communicate with one another via a bus 1370. In some cases, some of these components may not be present or may be combined in various combinations with one another or with other components not shown. These components might be located in a single physical entity or in more than one physical entity. Any actions described herein as being taken by the processor 1310 might be taken by the processor 1310 alone or by the processor 1310 in conjunction with one or more components shown or not shown in the drawing, such as the DSP 602 described above. Although the DSP 602 is shown as a separate component, the DSP 602 might be incorporated into the processor 1310.

The processor 1310 executes instructions, codes, computer programs, or scripts that it might access from the network connectivity devices 1320, RAM 1330, ROM 1340, or secondary storage 1350 (which might include various disk-based systems such as hard disk, floppy disk, or optical disk). While only one CPU 1310 is shown, multiple processors may be present. Thus, while instructions may be discussed as being executed by a processor, the instructions may be executed simultaneously, serially, or otherwise by one or multiple processors. The processor 1310 may be implemented as one or more CPU chips.

The network connectivity devices 1320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 1320 may enable the processor 1310 to communicate with the Internet or one or more telecommunications networks or other networks from which the processor 1310 might receive information or to which the processor 1310 might output information.

The network connectivity devices 1320 might also include one or more transceiver components 1325 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. The transceiver component 1325 might include separate receiving and transmitting units or a single transceiver. Information transmitted or received by the transceiver 1325 may include data that has been processed by the processor 1310 or instructions that are to be executed by processor 1310. Such information may be received from and outputted to a network in the form, for example, of a computer data baseband signal or signal embodied in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

The RAM 1330 might be used to store volatile data and perhaps to store instructions that are executed by the processor 1310. The ROM 1340 is a non-volatile memory device that typically has a smaller memory capacity than the memory capacity of the secondary storage 1350. ROM 1340 might be used to store instructions and perhaps data that are read during execution of the instructions. Access to both RAM 1330 and ROM 1340 is typically faster than to secondary storage 1350. The secondary storage 1350 is typically comprised of one or more disk drives or tape drives and might be used for non-volatile storage of data or as an over-flow data storage device if RAM 1330 is not large enough to hold all working data. Secondary storage 1350 may be used to store programs that are loaded into RAM 1330 when such programs are selected for execution.

The I/O devices 1360 may include liquid crystal displays (LCDs), touch screen displays, keyboards, keypads, switches, dials, mice, track balls, voice recognizers, card readers, paper tape readers, printers, video monitors, or other well-known input devices. Also, the transceiver 1325 might be considered to be a component of the I/O devices 1360 instead of or in addition to being a component of the network connectivity devices 1320. Some or all of the I/O devices 1360 may be substantially similar to various components depicted in the previously described drawing of the UA 501, such as the display 502 and the input 504.

Additional information related to the presence access layer and other topics discussed herein can be found in the following documents, which are incorporated herein by reference as if reproduced in their entirety: U.S. Provisional Patent Application No. 61/013,813, filed Dec. 14, 2007, by Brian McColgan, et al, entitled “Method and System for a Context Aware Mechanism for Use in Presence and Location”; U.S. Provisional Patent Application No. 61/013,827, filed Dec. 14, 2007, by Brian McColgan, et al, entitled “Method and System for a Context Aware Mechanism in an Integrated or Distributed Configuration”; and U.S. Provisional Patent Application No. 61/013,834, filed Dec. 14, 2007, by Brian McColgan, et al, entitled “Method and System for Specifying, Applying and Executing Application Related Aspects through Policies, Rules and/or Triggers”.

Presence-related information and watcher-related information might be transmitted in a number of different formats. The following examples provide names that might be used for various elements of such information and corresponding definitions for the names.

‘watcher-quantity’—Number of watchers currently interested (with optional list of watcher identities or addresses of record included).

‘grade’—Return a corresponding grade for a user. Argument may include individual identity of user or regular-expression defining a criteria/collection of one or more watchers—e.g. all my buddies from the ‘example.com’ domain might be *.example.com’. In multi-user case, an aggregate or computed grade is provided to the requestor.

‘level-of-interest’—Return the level of interest from a corresponding user. Argument may include individual watcher or regular-expression defining a criteria. In multiple-user case a computed or aggregate level of interest needs to be provided.

‘level-of-acquaintance’—Return level of acquaintance from a corresponding user. Same details as ‘level-of-interest’ above.

‘publication-frequency’—Return a publication frequency. Same format as for ‘level-of-interest’. That is, may apply to a single watcher, or more likely, a group of watchers.

‘on-grade’—When a grade reaches a prescribed level, PAL shall perform the corresponding action (e.g. send a notification). Default action is to send a notification toward the targeted user (e.g. grade(‘work-colleague’, AOR=‘Alice’) toward presentity ‘Bob’).

‘on-watcher-quantity’—When the quantity of outstanding watchers reaches a prescribed level, PAL shall perform the corresponding action (e.g. send a notification). Default action is to send a notification toward the targeted user (e.g. ‘on-watcher-quantity(0)’—no watchers left toward presentity ‘Bob’).

In an embodiment, a method for managing presence information sent from a presentity to a watcher is provided. The method includes the watcher providing watcher information to a presence aspect layer. The method further includes the presence aspect layer determining a manner for providing the presence information to the watcher based on an analysis of the watcher information.

In an alternative embodiment, a user agent is provided. The user agent includes a processor configured to provide watcher information associated with a watcher associated with a user of the user agent to a presence aspect layer. The presence aspect layer determines a manner for providing presence information to the watcher based on an analysis of the watcher information.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for managing presence information sent from a presentity to a watcher, comprising:
the watcher providing watcher information to a presence access layer; and
the presence access layer determining a manner for providing the presence information to the watcher based on an analysis of the watcher information.

2. The method of claim 1, wherein the watcher information is at least one of:
an identity of the watcher;
a quantity of watchers requesting presence information;
a type of information the watcher is interested in;
a graded level of the watcher's interest in the presence information;
a graded level of the watcher's degree of acquaintance toward the presentity; and
information related to a service available to the watcher.

3. The method of claim 2, wherein the manner for providing the presence information is at least one of:
decreasing a quantity of the presence information in a presence document provided by the presentity; and
decreasing a frequency with which the presentity provides the presence document to the watcher.

4. The method of claim 3, wherein the quantity of the presence information in the presence document is decreased when the watcher information indicates that the watcher is not interested in at least a portion of the presence information in the presence document.

5. The method of claim 3, wherein the frequency with which the presentity provides the presence document is decreased when the watcher information indicates at least one of:
the watcher is not interested in at least a portion of the presence information in the presence document;
the watcher requires presence information updates at a lower frequency;
the quality of service associated with the watcher mandates a lower frequency of updates; and
the watcher has a relatively low degree of acquaintance toward the presentity.

6. The method of claim 1, further comprising:
a plurality of watchers providing a plurality of watcher information to the presence access layer; and
the presence access layer aggregating the plurality of watcher information to determine the manner for providing the presence information to the plurality of watchers.

7. The method of claim 1, further comprising:
the presentity providing at least one presentity preference to the presence access layer; and
the presence access layer using the presentity preference in determining a manner for providing the presence information.

8. The method of claim 7, wherein the presentity preference is at least one of:
a graded level of the presentity's interest in providing the presence information to the watcher; and
a graded level of the presentity's degree of acquaintance toward the watcher.

9. The method of claim 1, wherein at least a portion of the presence access layer is co-located with the presentity.

10. The method of claim 1, wherein the analysis of the watcher information results in a grade for the watcher, and wherein the grade is given a variable name ‘grade’, and wherein ‘grade’ returns a corresponding grade for the watcher, and wherein arguments for ‘grade’ include at least one of an identity of the watcher and a regular expression defining a plurality of watchers, and wherein, when the plurality of watchers exists, ‘grade’ refers to an aggregate grade for the plurality of watchers.

11. The method of claim 2, wherein the quantity of watchers is given a variable name ‘watcher-quantity’, and wherein ‘watcher-quantity’ specifies a number of watchers currently interested in the presence information and includes an optional list containing at least one of an identity of the watcher and an address of record of the watcher.

12. The method of claim 2, wherein the level of the watcher's interest is given a variable name ‘level-of-interest’, and wherein ‘level-of-interest’ returns a level of interest of a corresponding watcher, and wherein arguments for ‘level-of-interest’ include at least one of an individual watcher and a regular expression defining a criterion, and wherein, in a multiple-watcher case, an aggregate level of interest is provided.

13. The method of claim 2, wherein the level of the watcher's degree of acquaintance is given a variable name ‘level-of-acquaintance’, and wherein ‘level-of-acquaintance’ returns a level of acquaintance of a corresponding watcher, and wherein arguments for ‘level-of-acquaintance’ include at least one of an individual watcher and a regular expression defining a criterion, and wherein, in a multiple-watcher case, an aggregate level of acquaintance is provided.

14. The method of claim 3, wherein the frequency with which the presentity provides the presence document to the watcher is given a variable name ‘publication-frequency’, and wherein ‘publication-frequency’ returns the frequency with which the presentity provides the presence document to the watcher, and wherein ‘publication-frequency’ applies to one of an individual watcher and a group of watchers.

15. The method of claim 10, wherein, when the grade reaches a prescribed level with a variable name ‘on-grade’, the presence access layer performs a corresponding action, wherein a default action is to send a notification toward a targeted user.

16. The method of claim 11, wherein, when a quantity of outstanding watchers reaches a prescribed level with a variable name ‘on-watcher-quantity’, the presence access layer performs a corresponding action, wherein a default action is to send a notification toward a targeted user.

17. A user agent, comprising:
a processor configured to provide watcher information associated with a watcher associated with a user of the user agent to a presence aspect layer, the presence aspect layer determining a manner for providing presence information to the watcher based on an analysis of the watcher information.

18. The user agent of claim 17, wherein the watcher information is at least one of:
an identity of the watcher;
a quantity of watchers requesting presence information;
a type of information the watcher is interested in;
a graded level of the watcher's interest in the presence information; and
a graded level of the watcher's degree of acquaintance toward the presentity; and
information related to a service available to the watcher.

19. The user agent of claim 18, wherein the manner for providing the presence information is at least one of:
decreasing a quantity of the presence information in a presence document provided by the presentity; and
decreasing a frequency with which the presentity provides the presence document to the watcher.

20. The user agent of claim 19, wherein the quantity of the presence information in the presence document is decreased when the watcher information indicates that the watcher is not interested in at least a portion of the presence information in the presence document.

21. The user agent of claim 19, wherein the frequency with which the presentity provides the presence document is decreased when the watcher information indicates at least one of:
the watcher is not interested in at least a portion of the presence information in the presence document;
the watcher requires presence information updates at a lower frequency;
the quality of service associated with the watcher mandates a lower frequency of updates; and
the watcher has a relatively low degree of acquaintance toward the presentity.

22. The user agent of claim 17 further comprising:
a plurality of watchers providing a plurality of watcher information to the presence access layer; and
the presence access layer aggregating the plurality of watcher information to determine the manner for providing the presence information to the plurality of watchers.

23. The user agent of claim 17, further comprising:
the presentity providing at least one presentity preference to the presence access layer; and
the presence access layer using the presentity preference in determining a manner for providing the presence information.

24. The user agent of claim 23, wherein the presentity preference is at least one of:
a graded level of the presentity's interest in providing the presence information to the watcher; and
a graded level of the presentity's degree of acquaintance toward the watcher.

25. The user agent of claim 17, wherein at least a portion of the presence access layer is co-located with the presentity.

26. The user agent of claim 17, wherein the analysis of the watcher information results in a grade for the watcher, and wherein the grade is given a variable name ‘grade’, and wherein ‘grade’ returns a corresponding grade for the watcher, and wherein arguments for ‘grade’ include at least one of an identity of the watcher and a regular expression defining a plurality of watchers, and wherein, when the plurality of watchers exists, ‘grade’ refers to an aggregate grade for the plurality of watchers.

27. The user agent of claim 18, wherein the quantity of watchers is given a variable name ‘watcher-quantity’, and wherein ‘watcher-quantity’ specifies a number of watchers currently interested in the presence information and includes an optional list containing at least one of an identity of the watcher and an address of record of the watcher.

28. The user agent of claim 18, wherein the level of the watcher's interest is given a variable name ‘level-of-interest’, and wherein ‘level-of-interest’ returns a level of interest of a corresponding watcher, and wherein arguments for ‘level-of-interest’ include at least one of an individual watcher and a regular expression defining a criterion, and wherein, in a multiple-watcher case, an aggregate level of interest is provided.

29. The user agent of claim 18, wherein the level of the watcher's degree of acquaintance is given a variable name ‘level-of-acquaintance’, and wherein ‘level-of-acquaintance’ returns a level of acquaintance of a corresponding watcher, and wherein arguments for ‘level-of-acquaintance’ include at least one of an individual watcher and a regular expression defining a criterion, and wherein, in a multiple-watcher case, an aggregate level of acquaintance is provided.

30. The user agent of claim 19, wherein the frequency with which the presentity provides the presence document to the watcher is given a variable name ‘publication-frequency’, and wherein ‘publication-frequency’ returns the frequency with which the presentity provides the presence document to the watcher, and wherein ‘publication-frequency’ applies to one of an individual watcher and a group of watchers.

31. The user agent of claim 26, wherein, when the grade reaches a prescribed level with a variable name ‘on-grade’, the presence access layer performs a corresponding action, wherein a default action is to send a notification toward a targeted user.

32. The user agent of claim 27, wherein, when a quantity of outstanding watchers reaches a prescribed level with a variable name ‘on-watcher-quantity’, the presence access layer performs a corresponding action, wherein a default action is to send a notification toward a targeted user.
